(19) United States
(12) Patent Application Publication
(10) Pub. No.: US 2014/0189621 A1
(43) Pub. Date: Jul. 3, 2014

(54) APPARATUS AND METHOD FOR MODELING CONTROLLER OF CAN BUS SIMULATOR

(71) Applicants: KYUNGSHIN CO., LTD., Incheon (KR); Hyundai Motor Company, Seoul (KR)

(72) Inventors: Jeong Hwan KIM, Seoul (KR); Hyun Cheol BAE, Suwon-si (KR); Chung Hi LEE, Seoul (KR); Jung Rea KIM, Incheon (KR); In Shik CHO, Incheon (KR)

(73) Assignees: KYUNGSHIN CO., LTD.; Hyundai Motor Company

(21) Appl. No.: 13/913,148

(22) Filed: Jun. 7, 2013

(30) Foreign Application Priority Data
Dec. 28, 2012 (KR) 10-2012-0156972

(51) Int. Cl. G06F 17/50

(52) U.S. Cl. CPC G06F 17/5009; G06F 17/5045; G06F 17/5081
USPC 716/103; 716/112

(57) ABSTRACT

An apparatus and a method for modeling a controller of a CAN bus are provided. The apparatus for modeling a controller of a CAN bus includes a modeling device for modeling a communication unit of a controller of the CAN bus and for evaluating the communication unit in a configuration of a CAN bus topology of the CAN bus. The modeling device includes an evaluation item determiner for determining the evaluation item used for simulating the configuration of the CAN bus topology, a factor determiner for determining factors that affect the evaluation result of the determined evaluation items, and a circuit design device for designing the circuit configured to include the determined factors.

### CROSS-REFERENCE TO RELATED APPLICATION

This application is based on and claims priority from Korean Patent Application No. 10-2012-0156972, filed on Dec. 28, 2012 in the Korean Intellectual Property Office, the disclosure of which is incorporated herein in its entirety by reference.

### TECHNICAL FIELD

The present disclosure relates to an apparatus and a method for modeling a controller of a controller area network (CAN) bus, and more particularly, to a technology of modeling a communication unit of the controller connected to the CAN bus in a simulator used for evaluating a configuration of a CAN bus topology.

### DESCRIPTION OF THE RELATED ART

Recently, the shortening of the development period of a product is an important factor in determining the competitiveness of the product, including products involved in the design of electric equipments of automobiles. The shortening of the development period is further hindered as products become increasingly complex due to the addition of new features.

In order to shorten a development time, a lot of development processes are simultaneously conducted. However, in the case of designing system-level products such as a controller area network (CAN) bus topology, it is difficult to obtain detailed design data for each component of the system in a timely fashion. For example, it may be difficult to obtain detailed design data for a controller for configuring the CAN bus topology in a timely fashion. In addition, the detailed design data for the controller may not be shared due to security issues.

A simulator can be utilized to verify the design of the CAN bus topology. However, it is difficult to accurately verify the CAN bus topology when detailed design data for the bus controller is not available.

### SUMMARY

The present disclosure is made in view of the above problems, and provides an apparatus and a method for modeling a controller of a control area network (CAN) bus. In particular, the present disclosure provides an apparatus and a method for modeling a communication unit of the controller connected to a CAN bus. The model can be used in the simulator of the CAN bus to evaluate a configuration of a CAN bus topology.

Particularly, the present disclosure provides an apparatus and a method for modeling a controller of a CAN bus while minimizing dependency on design information of the controller.

In addition, the present disclosure further provides an apparatus and a method for modeling a controller of a CAN bus capable of modeling the controller without requiring design information of a communication unit of the controller by designing a circuit using a black box modeling scheme.

In accordance with an aspect of the present disclosure, an apparatus for modeling a controller of a CAN bus includes a modeling device configured to model a communication unit of the controller of the CAN bus and for evaluating the communication unit in a configuration of a CAN bus topology. The modeling device includes: an evaluation item determiner configured to determine an evaluation item used for simulating the configuration of the CAN bus topology; a factor determiner configured to determine factors that affect an evaluation result of the determined evaluation item; and a circuit design device configured to design a circuit configured by the determined factors. The circuit design device designs the circuit characterized by the determined factors by using a black-box modeling scheme. The circuit design device designs an equivalent circuit having input and output characteristics of the communication unit. The equivalent circuit having the output characteristic includes an output FET equivalent switch, an output impedance, and an inverse current prevention diode. The equivalent circuit having the output characteristic is characterized by a dominant output voltage and a recessive output voltage, and has a current drive capability determined by a short circuit output current. The equivalent circuit having the input characteristic comprises an input equivalent resistance and input equivalent capacitance of a common mode and an input equivalent resistance and input equivalent capacitance of a differential mode. In accordance with an aspect of the present disclosure, an apparatus for modeling the controller of the CAN bus further includes a parameter quantifier configured to measure or calculate a parameter value for each of the determined factors so as to quantify the parameter values. In accordance with an aspect of the present disclosure, an apparatus for modeling the controller of the CAN bus further includes a model generation device configured to generate a circuit model of the communication unit by applying the parameter values quantified by the parameter quantifier to the circuit designed by the circuit design device.

In accordance with another aspect of the present disclosure, a method for modeling a controller of a CAN bus includes: determining, by an evaluation item determiner, an evaluation item used for simulating a configuration of a CAN bus topology; determining, by a factor determiner, factors that affect an evaluation result of the determined evaluation item; and designing, by a circuit design device, a circuit modeling a communication unit of the controller of the CAN bus using the determined factors. Designing the circuit includes designing a circuit characterized by the determined factors by using a black box modeling scheme. Designing the circuit includes designing an equivalent circuit having input and output characteristics of the communication unit. Designing the circuit includes designing the equivalent circuit having the output characteristic using an output FET equivalent switch, an output impedance, and an inverse current prevention diode. The equivalent circuit having the output characteristic is characterized by a dominant output voltage and a recessive output voltage, and has a current drive capability determined by a short circuit output current. Designing the circuit includes designing the equivalent circuit having the input characteristic using an input equivalent resistance and input equivalent capacitance of a common mode and an input equivalent resistance and input equivalent capacitance of a differential mode. In accordance with another aspect of the present disclosure, a method for modeling the controller of the CAN bus further includes measuring and calculating, by a parameter quantifier, the parameter value for each of the determined factors to quantify the parameter values. In accordance with another aspect of the present disclosure, a method for modeling the controller of the CAN bus simulator further includes generating, by a model generation device, a circuit model of the communication unit by applying the parameter values quantified by the parameter quantifier to the circuit designed by the circuit design device.

### BRIEF DESCRIPTION OF THE DRAWINGS

The objects, features and advantages of the present disclosure will be more apparent from the following detailed description in conjunction with the accompanying drawings, in which:

FIG. 1 is a block diagram illustrating a configuration of an apparatus for modeling a controller according to an exemplary embodiment of the present disclosure;

FIG. 2 is an illustrative circuit diagram showing a circuit model of a communication unit generated by an apparatus for modeling a controller according to the exemplary embodiment of the present disclosure;

FIGS. 3 and 4 are illustrative diagrams showing operative examples of quantifying of parameter values for the circuit model of the communication unit according to the exemplary embodiment of the present disclosure; and

FIG. 5 is a flow chart illustrating an operation flow of a method for modeling a controller according to the exemplary embodiment of the present disclosure.

### DETAILED DESCRIPTION

Exemplary embodiments of the present disclosure are described with reference to the accompanying drawings. The same reference numbers are used throughout the drawings to refer to the same or like parts. Detailed descriptions of well-known functions and structures incorporated herein may be omitted to avoid obscuring the subject matter of the present disclosure.

Hereinafter, exemplary embodiments of the present disclosure will be described in detail with reference to the accompanying drawings.

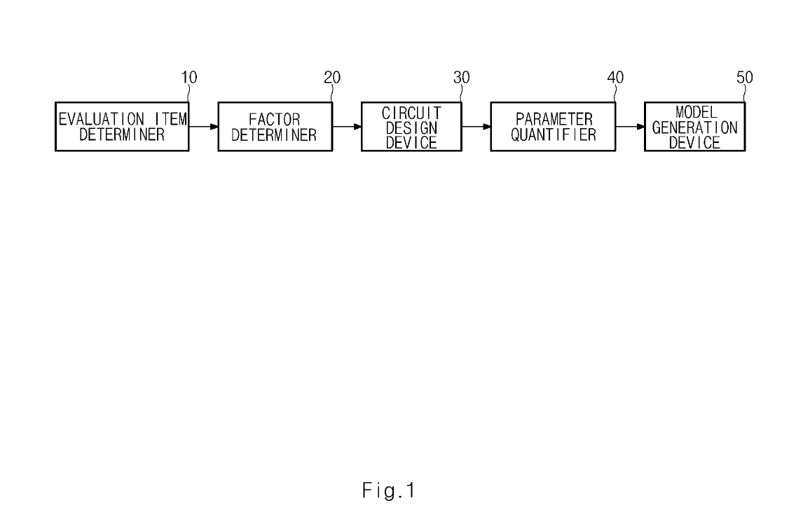

FIG. 1 is a block diagram illustrating a configuration of an apparatus for modeling a controller according to an exemplary embodiment of the present disclosure.

Referring to FIG. 1, the apparatus for modeling the controller of a controller area network (CAN) bus (hereinafter, referred to as ‘an apparatus for modeling a controller’) according to an exemplary embodiment of the present disclosure includes a modeling device for modeling a communication unit of the controller. The controller of the CAN bus is generally connected to a CAN bus, or to a CAN bus simulator used to evaluate a configuration of a CAN bus topology. As shown, the modeling device includes an evaluation item determiner 10, a factor determiner 20, a circuit design device 30, a parameter quantifier 40, and a model generation device 50, that are in communication with each other.

First, the evaluation item determiner 10 determines the evaluation item used for simulating the configuration of the CAN bus topology. The evaluation item may form part of the CAN bus simulator used to simulate and evaluate the configure of the CAN bus topology. The determination of the evaluation item may include identifying the component or item that will be evaluated. The determination can further include identifying characteristics of the component, such as identifying input and output port(s) of the evaluation item, determining functional characteristics of the input and output ports (e.g., input or output resistance and/or capacitance), determining functional relationships between signals applied to the input port(s) and signals output from the output port(s), or the like.

The factor determiner 20 determines the factor(s) that affect the evaluation result of the evaluation items determined by the evaluation item determiner 10. As an example, the factor determiner 20 may determine that an output FET equivalent switch, an output impedance, an inverse current prevention diode, an input equivalent resistance and input equivalent capacitance of a common mode, and an input equivalent resistance and input equivalent capacitance of a differential mode are the factor(s). For example, the factor determiner 20 may determine the principal factor(s) affecting the functional characteristic of the input and output ports, and affecting the functional relationship between signals applied to the input port(s) and signals output from the output port(s). In addition, the factor determiner 20 may identify circuit components that exhibit behaviors or characteristics that are similar to those of the principal factor(s), such as output FET equivalent switches having particular operational parameters, impedance, resistance, capacitance or inductance elements having particular operational values (e.g., impedance, resistance, capacitance, or inductance values, etc.), diodes having particular operational parameters (e.g., threshold voltage, etc.), or the like.

The circuit design device 30 designs the circuit configured to include the determined factor(s). Here, the circuit design device 30 designs the circuit configured by the factors determined using a black box modeling scheme. For example, the circuit design device 30 may design a circuit including the circuit components identified by the factor determiner (and having the operational values determined by the factor determiner).

In this case, the circuit design device 30 designs the equivalent circuit such that the equivalent circuit has the input and output characteristics of the communication unit.

As an example, the circuit design device 30 may design the equivalent circuit such that the equivalent circuit has the output characteristic of the communication unit. The circuit design device 30 may design the equivalent circuit using the output FET equivalent switch, the output impedance, and the inverse current prevention diode. In this case, the equivalent circuit is configured to have an output characteristic characterized by a dominant output voltage and a recessive output voltage, and the current drive capability can be determined by a short circuit output current.

In addition, the circuit design device 30 may design the equivalent circuit such that the equivalent circuit has the input characteristic of the communication unit. The circuit design device 30 may design the equivalent circuit using the input equivalent resistance and input equivalent capacitance of the common mode, and the input equivalent resistance and input equivalent capacitance of the differential mode.

Meanwhile, in the circuit design device 30, a specific function may be further implemented when the function is capable of adding a separate factor on the circuit which is designed in preparation for the case in which a common mode choke, a termination resistance, and the like are installed in the controller.

The parameter quantifier 40 measures or calculates the parameter value for each factor on or component of the circuit designed by the circuit design device 30, so as to quantify the parameter value. Here, the parameter value may be input in a form of source code. At this time, an electric characteristic of the controller is determined by the input parameter value. In the case in which the separate factor is added on the circuit designed by the circuit design device 30, the parameter value may be input through an additional option function.

The model generation device 50 generates a final circuit model for the communication unit by applying the parameter value(s) quantified by the parameter quantifier 40 to the circuit designed by the circuit design device 30. As a result, each component of the final circuit model identified by the circuit design device 30 exhibits the functional characteristics (e.g., resistance, capacitance, or other input/output relationship) according to the parameter values quantified by the parameter quantifier 40.

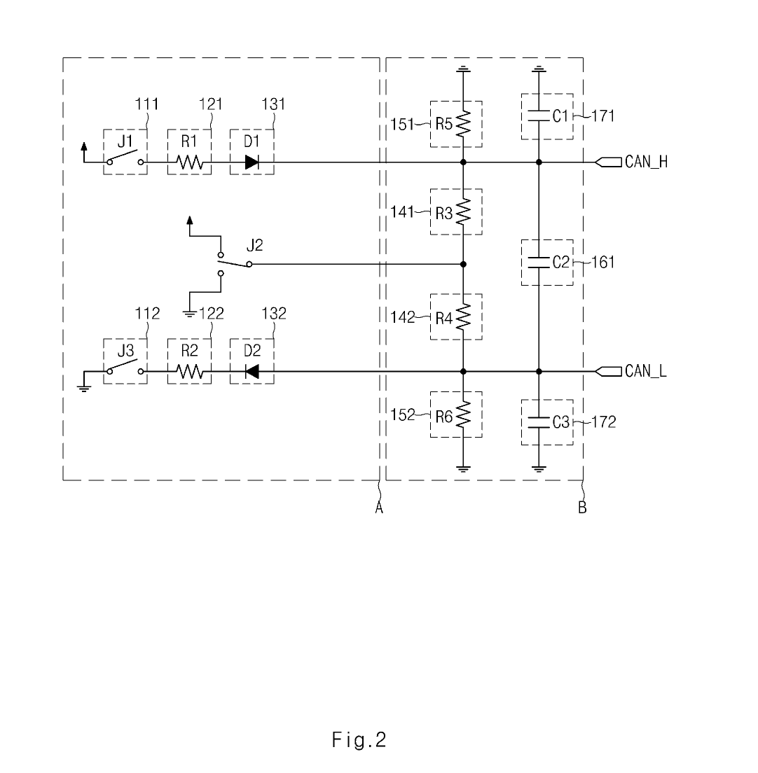

FIG. 2 is an illustrative circuit diagram showing a circuit model of a communication unit generated by an apparatus for modeling a controller according to the exemplary embodiment of the present disclosure.

Referring to FIG. 2, ‘A’ indicates the output characteristic model, and ‘B’ indicates the input characteristic model.

In the output characteristic model ‘A’, J1 111 and J3 112 are the output FET equivalent switches, R1 121 and R2 122 are the output impedances, and D1 131 and D2 132 are the inverse current prevention diodes. In this case, the output characteristic model is configured by the dominant output voltage and the recessive output voltage, and the current drive capability may be determined by a short circuit output current.

Meanwhile, in the input characteristic model ‘B’, R3 141 and R4 142 are the input equivalent resistances of the differential mode, R5 151 and R6 152 are the input equivalent resistances of the common mode, C2 161 is the input equivalent capacitance of the differential mode, and C1 171 and C3 172 are the input equivalent capacitances of the common mode.

Here, the J1 111, R1 121, and D1 131 are connected in series between a power supply node and a high end CAN_H of the CAN bus. In addition, one end of the R3 141 is connected with the high end CAN_H of the CAN bus and the other end is connected with the R4 142. One end of each of the R5 151 and C1 171 is connected with the high end CAN_H of the CAN bus, while the other end of each of the R5 151 and C1 171 is connected with a ground terminal.

Meanwhile, the J3 112, R2 122, and D2 132 are connected in series between a ground node and a low end CAN_L of the CAN bus. In addition, one end of the R4 is connected with the low end CAN_L of the CAN bus and the other end is connected with the R3 141. One end of each of the R6 152 and C3 172 is connected with the low end CAN_L of the CAN bus, while the other end of each of the R6 152 and C3 172 is connected with the ground terminal. In addition, one end of the C2 161 is connected with the high end CAN_H of the CAN bus and the other end is connected with the low end CAN_L of the CAN bus.

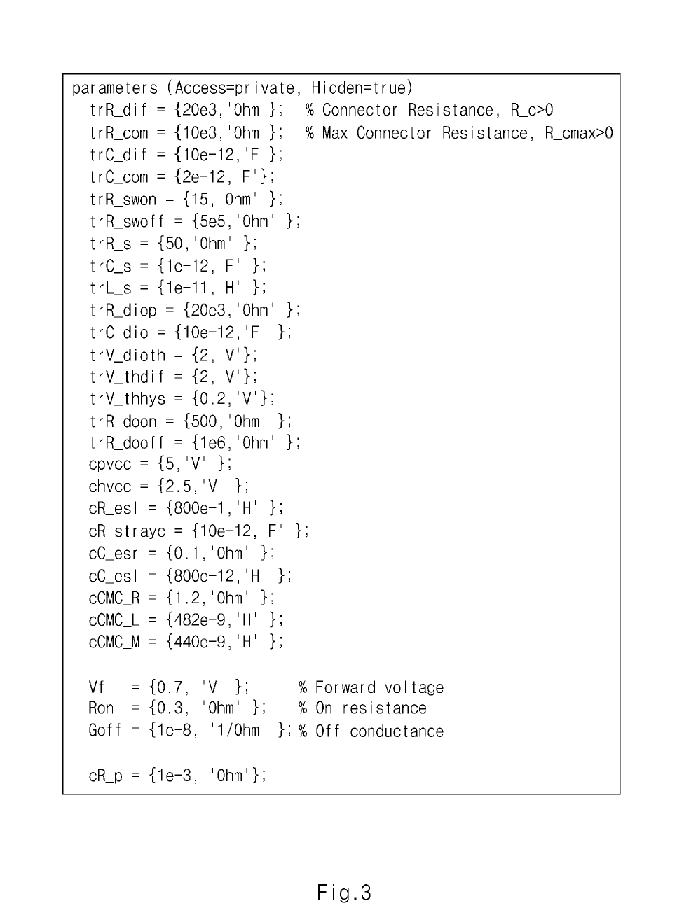

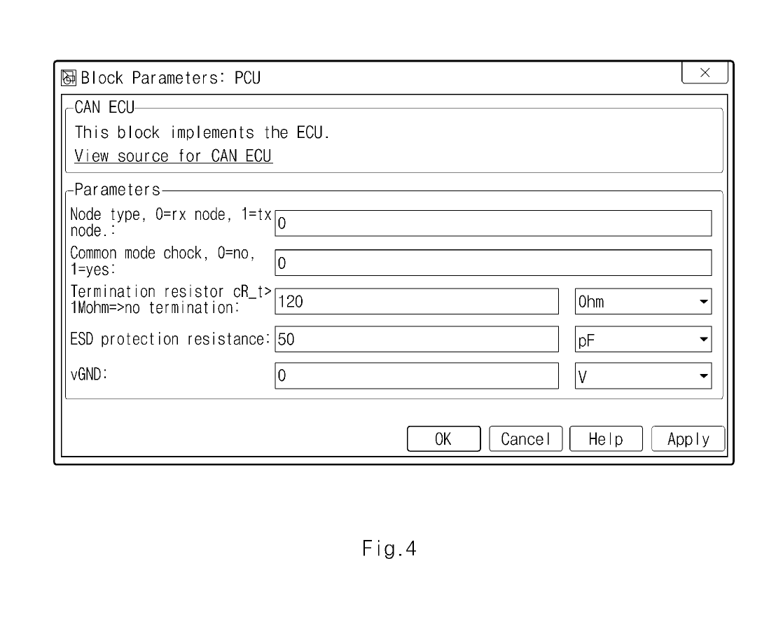

FIGS. 3 and 4 are illustrative diagrams showing operative examples of quantifying of parameter values for the circuit model of the communication unit according to the exemplary embodiment of the present disclosure.

The parameter values for the factors of the circuit designed by a circuit design device 30 are measured or calculated to quantify the parameter values. In this case, the quantified parameter values may be input in the form of source code, as shown in FIG. 3, and/or may be input using a parameter input function which is separately implemented, as shown in FIG. 4. The source code may determine the operational behavior or characteristic (e.g., the input/output function provided) of each circuit component, including the operational parameter value(s) of the component. The parameter input function may similarly be used to input the operational behavior of each component into the model.

An operation flow of an apparatus for modeling a controller according to the exemplary embodiment of the present disclosure configured as described above will be described in detail.

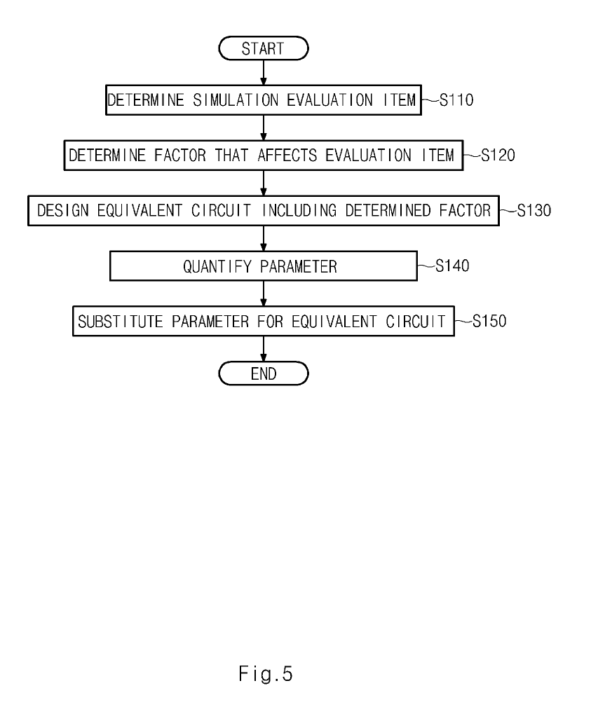

FIG. 5 is a flow chart illustrating an operation flow of a method for modeling a controller by an apparatus for modeling a controller according to the exemplary embodiment of the present disclosure.

Referring to FIG. 5, in the apparatus for modeling a controller, the evaluation item determiner 10 determines the evaluation items of the simulator which simulates the configuration of the CAN bus topology (step S110), and the factor determiner 20 determines the factors that affect the evaluation result of the evaluation item determined at step S110 (step S120).

Then, the circuit design device 30 designs the circuit applied to the communication unit of the controller which is connected to the CAN bus in the simulator by using the factors determined at step S120 (step S130).

At step S130, the equivalent circuit for the input and output characteristics of the communication unit is designed by using the black box modeling scheme. An illustrative circuit designed at step S130 is described with reference to the exemplary embodiment of FIG. 2.

Meanwhile, the parameter quantifier 40 measures and calculates the parameter value for each factor of the circuit designed at step S130 to quantify the parameter (step S140), and the model generation device 50 generates the circuit model of the communication unit of the controller by applying the parameter value quantified at step S140 to the circuit designed at step S130 (step S 150).

As set forth above, according to the exemplary embodiment of the present disclosure, since the circuit is configured using a factor that may affect the simulation evaluation items in modeling the communication unit of the controller connected to a CAN bus, the dependency on the design information of the controller may be minimized, thereby making it possible to increase efficiency of a development process according to the circuit model design.

Further, the exemplary embodiment of the present disclosure designs the circuit using the black box modeling scheme, so that modeling may be performed without the design information of the circuit for the communication unit of the controller, thereby making it possible to reduce the circuit design time.

Although the apparatus and the method for modeling a controller of the CAN bus simulator according to the exemplary embodiment of the present disclosure have been described with reference to the accompanying drawings, the present disclosure is not limited to the exemplary embodiment and the accompanying drawings disclosed in the present specification, but may be modified without departing from the scope and spirit of the present disclosure.

1. An apparatus for modeling a controller of a controller area network (CAN) bus, the apparatus comprising:
a modeling device configured to model a communication unit of the controller of the CAN bus and for evaluating the communication unit in a configuration of a CAN bus topology,
wherein the modeling device comprises:
an evaluation item determiner configured to determine an evaluation item used for simulating the configuration of the CAN bus topology;
a factor determiner configured to determine factors that affect an evaluation result of the determined evaluation item; and
a circuit design device configured to design a circuit configured by the determined factors,
wherein the circuit design device adds a separate factor on the circuit for the case in which a common mode choke and a termination resistance are installed in the controller.

2. The apparatus for modeling the controller of the CAN bus of claim 1, wherein the circuit design device designs the circuit characterized by the determined factors by using a black-box modeling scheme.

3. The apparatus for modeling the controller of the CAN bus of claim 2, wherein the circuit design device designs an equivalent circuit having input and output characteristics of the communication unit.

4. The apparatus for modeling the controller of the CAN bus of claim 3, wherein the equivalent circuit having the output characteristic comprises an output FET equivalent switch, an output impedance, and an inverse current prevention diode.

5. The apparatus for modeling the controller of the CAN bus of claim 3, wherein the equivalent circuit having the output characteristic is characterized by a dominant output voltage and a recessive output voltage, and has a current drive capability determined by a short circuit output current.

6. The apparatus for modeling the controller of the CAN bus of claim 3, wherein the equivalent circuit having the input characteristic comprises an input equivalent resistance and input equivalent capacitance of a common mode and an input equivalent resistance and input equivalent capacitance of a differential mode.

7. The apparatus for modeling the controller of the CAN bus of claim 1, further comprising:
a parameter quantifier configured to measure or calculate a parameter value for each of the determined factors so as to quantify the parameter values.

8. The apparatus for modeling the controller of the CAN bus simulator of claim 7, further comprising:
a model generation device configured to generate a circuit model of the communication unit by applying the parameter values quantified by the parameter quantifier to the circuit designed by the circuit design device.

9. A method for modeling a controller of a controller area network (CAN) bus by using a modeling device, the method comprising:
determining, by an evaluation item determiner of the modeling device, an evaluation item used for simulating a configuration of a CAN bus topology;
determining, by a factor determiner communicatively coupled to the evaluation item determiner, factors that affect an evaluation result of the determined evaluation item; designing, by a circuit design device communicatively coupled to the factor determiner, a circuit modeling a communication unit of the controller of the CAN bus using the determined factors; and
adding, by the circuit design device, a separate factor on the circuit for the case in which a common mode choke and a termination resistance are installed in the controller.

10. The method for modeling the controller of the CAN bus of claim 9, wherein the designing the circuit comprises designing a circuit characterized by the determined factors by using a black box modeling scheme.

11. The method for modeling the controller of the CAN bus of claim 10, wherein the designing the circuit comprises designing an equivalent circuit having input and output characteristics of the communication unit.

12. The method for modeling the controller of the CAN bus of claim 11, wherein the designing the circuit comprises designing the equivalent circuit having the output characteristic using an output FET equivalent switch, an output impedance, and an inverse current prevention diode.

13. The method for modeling the controller of the CAN bus of claim 12, wherein the equivalent circuit having the output characteristic is characterized by a dominant output voltage and a recessive output voltage, and has a current drive capability determined by a short circuit output current.

14. The method for modeling the controller of the CAN bus of claim 11, wherein the designing the circuit comprises designing the equivalent circuit having the input characteristic using an input equivalent resistance and input equivalent capacitance of a common mode and an input equivalent resistance and input equivalent capacitance of a differential mode.

15. The method for modeling the controller of the CAN bus of claim 9, further comprising:
measuring and calculating, by a parameter quantifier of the modeling device, the parameter value for each of the determined factors to quantify the parameter values.

16. The method for modeling the controller of the CAN bus of claim 15, further comprising:
generating, by a model generation device of the modeling device, a circuit model of the communication unit by applying the parameter values quantified by the parameter quantifier to the circuit designed by the circuit design device.
